(19) United States
(12) Patent Application Publication
(10) Pub. No.: US 2011/0154832 A1
(43) Pub. Date: Jun. 30, 2011

(54) COMPOSITION AND METHOD FOR PRODUCING THE SAME

(75) Inventors: Jayeshkumar Jayanarayan Barve, Bangalore (IN); Sudhakar Eddula Reddy, Bangalore (IN); Chandrasekhar Samiappan, Bangalore (IN); Duraiswamy Srinivasan, Bangalore (IN); Francis Johnson, Clifton Park, NY (US); Atanu Saha, Bangalore (IN)

(73) Assignee: GENERAL ELECTRIC COMPANY, Schenectady, NY (US)

(21) Appl. No.: 12/648,314

(22) Filed: Dec. 29, 2009

(51) Int. Cl. F25B 21/00; F28D 17/00; C09K 5/04; B05D 5/00

(52) U.S. Cl. 62/3.1; 165/4; 252/67; 427/127

(57) ABSTRACT

Provided is a method that includes providing a granular first material (e.g., a magnetocaloric material) and a sinterable second material. The granular first material and the sinterable second material can be combined to form an aggregate. Once the aggregate has been formed, localized sintering of the aggregate can be performed, for example, such that, subsequent to localized sintering, the second material is substantially contiguous and binds the granular first material. Associated compositions and systems are also provided.

### BACKGROUND

The magnetocaloric effect is a phenomenon whereby, for appropriately chosen materials (referred to as “magnetocaloric materials”), a change in the temperature of the material can be induced by exposing the material to a changing magnetic field. Specifically, increasing the magnitude of an externally applied magnetic field orders the magnetic moments within the material, increasing the temperature via the magnetocaloric effect. Conversely, decreasing the magnitude of the externally applied magnetic field disorders the magnetic moments within the material, reducing temperature via the magnetocaloric effect.

### BRIEF DESCRIPTION

In one aspect, a composition is provided. The composition can include a substantially contiguous second material interspersed with a granular first material. For example, the contiguous second material can be configured so as to bind together the granular first material. The granular first material may constitutes less than or equal to about 50 volume percent of the composition.

The granular first material may have granules with diameters less than or equal to about 500 μm, may have a melting temperature greater than or equal to about 400° C., and may exhibit a strain to failure of less than 1% at room temperature. In one embodiment, the granular first material may include magnetocaloric material. The second material can have a melting temperature less than or equal to about 1500° C.

In another aspect, a method is provided, which method includes providing a granular first material (e.g., a magnetocaloric material) and a sinterable second material. In some embodiments, the granular first material may be exposed to an isotropic chemical etchant. The granular first material and the sinterable second material can be combined to form an aggregate. In one embodiment, the sinterable second material may be granular, and the granular first and second materials can be mixed to form the aggregate. In another embodiment, the sinterable second material can be provided as a second material source and coated onto the granular first material.

Once the aggregate has been formed, localized sintering of the aggregate can be performed, for example, such that, subsequent to localized sintering, the second material is substantially contiguous and binds the granular first material. The localized sintering of the aggregate can be via a heating using a source such as, for example, a laser, a microwave radiation source, a radio frequency radiation source, an infrared radiation source, and/or an ultraviolet radiation source.

The aggregate can be incorporated into a regenerator. Where the first material includes magnetocaloric material, a magnetic field generating component can be provided, the magnetic field generating component being configured to vary a magnetic field to which the magnetocaloric material is exposed. A working fluid can be directed along the regenerator so as to exchange thermal energy (“heat”) with the magnetocaloric material.

In yet another aspect, an apparatus is provided. The apparatus can include a regenerator including a contiguous second material interspersed with and binding together a granular magnetocaloric material. A magnetic field generating component can be configured to vary a magnetic field to which the magnetocaloric material is exposed. A working fluid can be directed along the regenerator so as to exchange heat with the magnetocaloric material.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic view of a composition configured in accordance with an example embodiment;

FIG. 2 is a schematic view of a composition configured in accordance with another example embodiment;

FIGS. 3-5 are a schematic representation of a method for making a composition, the method being in accordance with an example embodiment;

FIGS. 6-8 are a schematic representation of a method for making a composition, the method being in accordance with another example embodiment;

FIG. 9 is a perspective view of a regenerator for a magnetic refrigeration system;

FIG. 10 is a magnified plan view of the area labeled 10 in FIG. 9;

FIG. 11 is a schematic view of a magnetic refrigeration system;

FIG. 12 is a magnified perspective view of the area labeled 12 in FIG. 9;

FIG. 13 is a magnified plan view of the area labeled 13 in FIG. 12; and

FIG. 14 is a magnified plan view of the area labeled 14 in FIG. 12.

### DETAILED DESCRIPTION

Example embodiments of the present invention are described below in detail with reference to the accompanying drawings, where the same reference numerals denote the same parts throughout the drawings. Some of these embodiments may address the above and other needs.

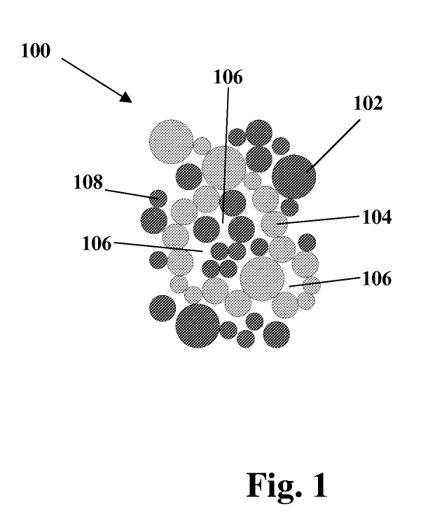

Referring to FIG. 1, therein is depicted a composition 100 configured in accordance with an example embodiment. The composition 100 can include a granular first material 102. The granular first material 102 may include granules of any shape, including, for example, one or more of spherical, cubic, pyramidal, etc. Regardless of shape, the granules may have diameters less than or equal to about 500 μm, and in some cases less than or equal to about 100 μm, and in other cases less than or equal to about 50 μm. The granular first material 102 can have a melting temperature greater than or equal to about 400° C., and may exhibit a strain to failure of less than 1% at room temperature. As such, the granular first material 102 may be a relatively brittle, relatively high melting temperature material. Examples of candidate granular first materials include, for example, ceramics, intermetallics, oxides, nitrides, and magnetocaloric materials (which may be, for example, intermetallics).

A substantially contiguous second material 104 may be interspersed with the granular first material 102, for example, so as to bind together the granular first material. While the second material 104 may fill much of the volume between granules of the first material 102, the second material may also define voids 106 therein. Other voids 106 may exist between granules of the first material 102 and/or between the first and second materials. The second material 104 can include a metal, and can have a melting temperature less than or equal to about 1500° C. Examples of candidate second materials include, for example, gold, silver, copper, and/or certain alloys of nickel (e.g., nickel-50 atomic percent iron, nickel-bronze).

The composition 100 can also include a third material 108, which may also be granular. The third material may have properties consistent with either of the first or second materials 102, 104.

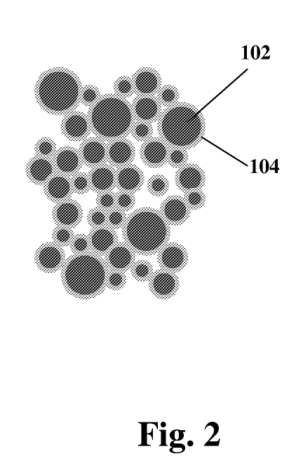

The second material 104 may be interspersed with the granular first material 102, in a variety of ways that allow the second material to bind together the first material. For example, still referring to FIG. 1, the second material 104 may form a matrix within which granules of the first material 102 are randomly distributed and physically and/or chemically bonded. Alternatively, or additionally, referring to FIG. 2, the second material 104 may act to surround individual granules of the first material 102. In either case, the granular first material may constitute anywhere from a small but non-trivial amount of the composition 100 up to 50 volume percent of the overall composition.

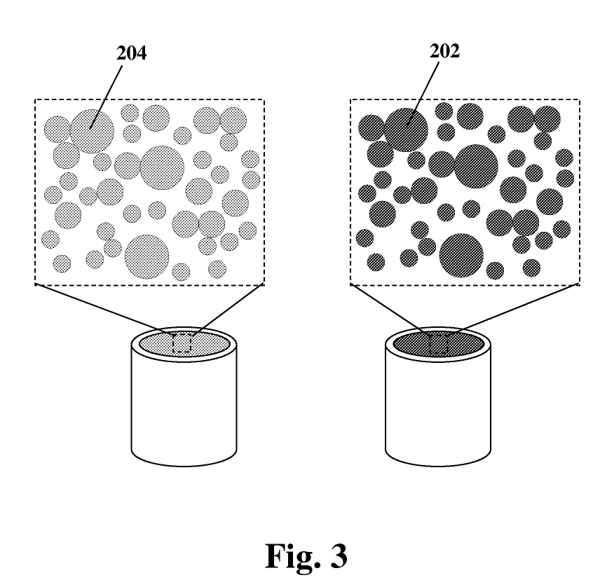

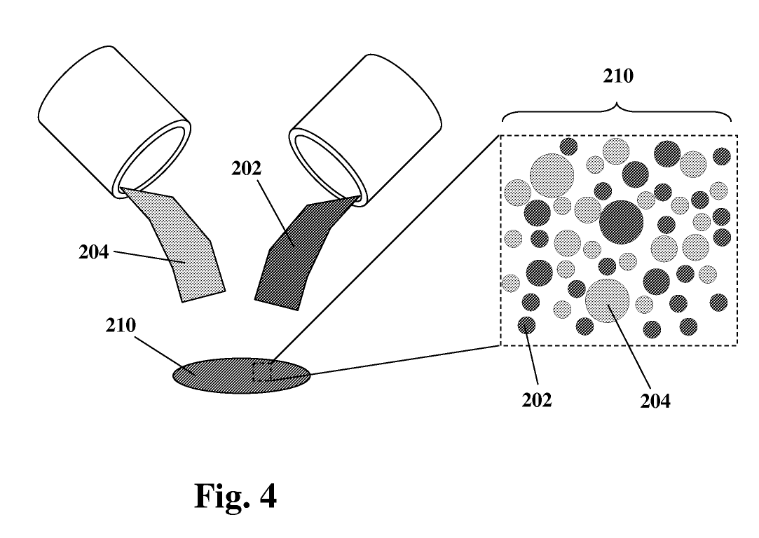

Referring to FIGS. 3-5, therein is represented a method for making a composition configured in accordance with an example embodiment, such as the composition 100 of FIG. 1. Initially, a granular first material 202 can be provided, along with a sinterable second material 204 (FIG. 3). In this case, “sinterable” refers to the tendency for previously discrete bodies to become joined, without melting, due to the input of energy. The sinterable second material 204 can be provided in a flowable form, for example, as a slurry, a suspension, or in granular form. The granular first material 202 and the sinterable second material 204 can then be combined to form an aggregate 210 (FIG. 4). For example, where the second material 204 is provided in granular form, the first material 202 and second material can be physically mixed together in order to create a substantially homogeneous combination of the two.

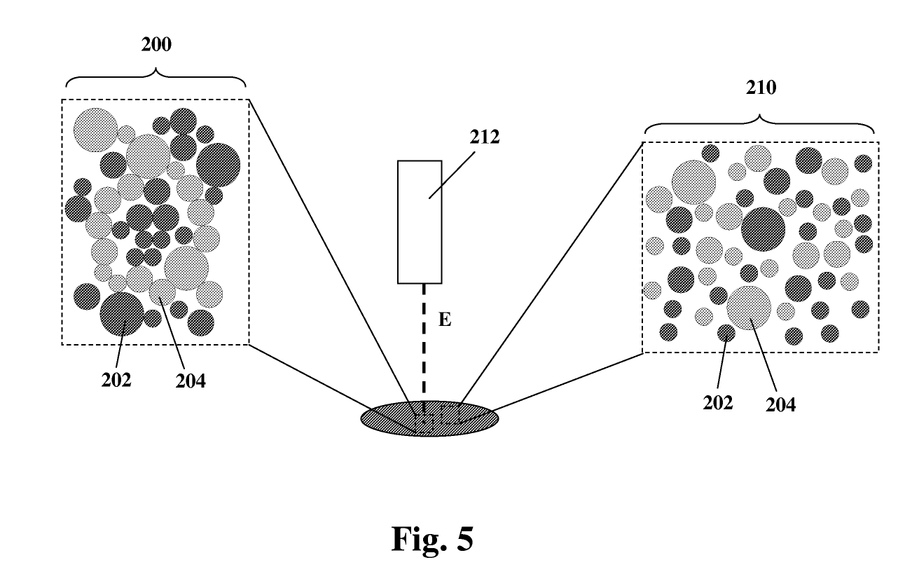

Finally, localized sintering of the aggregate 210 can be performed (FIG. 5). For example, an energy source 212 can be used to supply an energetic beam E to a localized area (say, 100 μm by 100 μm) of the aggregate 210. The energetic beam E supplies energy to the localized area of the aggregate 210, resulting in localized heating and sintering of the second material 204 and the production of a composition 200 in the localized area, the composition including the granular first material 202 bound together by the second material 204. Portions of the aggregate 210 that are outside the localized area may remain as they were before localized sintering was performed.

The energy source 212 can be any component capable of producing an energetic beam capable of imparting sufficient energy to the second material 204 to cause sintering thereof and capable of imparting that energy in a localized area, such that second material outside the localized area would not receive sufficient energy to induce sintering. Examples of possible energy sources include, but are not limited to, a laser, a microwave radiation source, a radio frequency (RF) radiation source, an infrared radiation source, an ultraviolet radiation source, an electron beam source, and an ion beam source. In each case, the emitted energetic radiation/particles that form the energetic beam E may be focused onto a localized area, for example, with one or more appropriately chosen lenses.

The granular first material 202 can have a melting temperature greater than or equal to about 400° C., while the sinterable second material 204 can have a melting temperature less than or equal to about 1100° C. Further, the first and second materials 202, 204 can be chosen such that the energy imparted by the energy source 212 acts to induce sintering in the latter but not in the former. For example, the first material 202 may be chosen to have a melting temperature higher than that of the second material 204. In one example, the granular first material 202 can be an intermetallic, while the second material 204 can be gold.

As mentioned above, the granules of the first material 202 can be any shape. The granules of the second material 204 may also be any shape. In some embodiments, the sintering process may be facilitated through the use of a first material 202 and/or a second material 204 having granules with generally regular surface profiles, such that the surfaces of the granules lack asperities, protrusions, sharp indentations, etc. (other than nanometer and/or atomic level roughness). For example, this may allow the granules to flow past one another more readily, thereby helping to avoid instances of unusually low density and/or voids in the final sintered composition. In order to produce granules having a sufficiently smooth surface, the granules may be subjected to an isotropic chemical etch, which will tend to preferentially etch more pronounced surface features. Alternately, such regular granule surface profile can be achieved by producing the granules by atomization process.

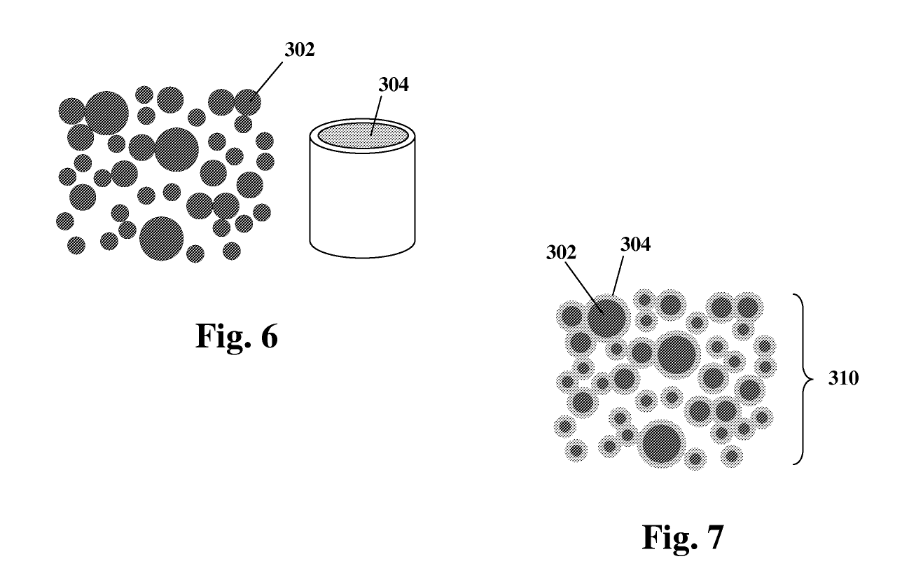

Referring to FIGS. 6-8, therein is represented another method for making a composition configured in accordance with an example embodiment, such as the composition 100 of FIG. 1. Initially, a granular first material 302 can be provided, along with a separate source of sinterable second material 304 (FIG. 6). The granules of the first material 302 can then be coated with the second material 304 to form an aggregate 310 of the first and second materials (FIG. 7). The coating of the second material 304 onto the first material 302 can be accomplished in a variety of ways. For example, the second material 304 can be supplied as a vapor deposition source and can be vapor deposited (e.g., physical vapor deposition and/or chemical vapor deposition) onto the first material 302, can be supplied as part of an electrolytic or electroless coating bath and plated onto the first material, and/or can be supplied in a form that allows for dip coating of the second material onto the first.

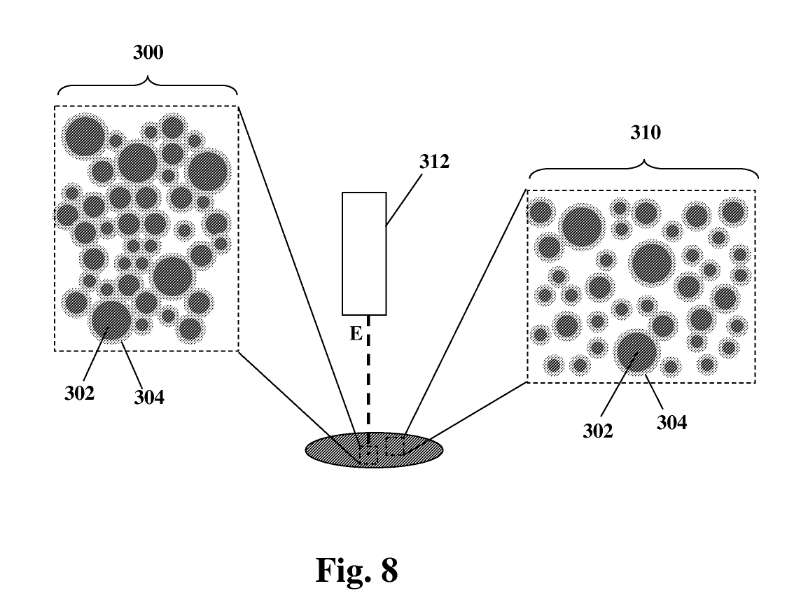

Subsequent to coating of the second material 304 onto the first material 302, localized sintering of the aggregate 310 can be performed (FIG. 8). Again, as an example, an energy source 312 can be used to supply an energetic beam E to a localized area (say, 100 μm by 100 μm) of the aggregate 310. The energetic beam E can supply energy to the localized area of the aggregate 310, resulting in localized sintering of the second material 304 and the production of a composition 300 in the localized area, the composition including the granular first material 302 bound together by the second material 304. Portions of the aggregate 310 that are outside the localized area may remain as they were before localized sintering was performed.

The methods described above may allow for the production of components having substantially complex geometries while being composed substantially of brittle materials. Brittle materials are often difficult to work with due to the difficulty associated with forming such materials into component parts. Specifically, brittle materials are often not amenable to typical machining processes utilized in metal working processes. By utilising a granular form of the brittle material interspersed with a sinterable second material, an aggregate can produced that can be locally sintered to form parts with complex, irregular, or high aspect ratio geometries. The resultant parts can be substantially composed (say, up to about 50% by volume, and in some cases 80% or more) of the brittle material. Sufficient amounts of the second material (e.g., at least 20% by volume of the total aggregate) can be mixed with the brittle first material in order to ensure that, upon sintering, the second material forms a substantially contiguous matrix that binds the granules of the brittle material.

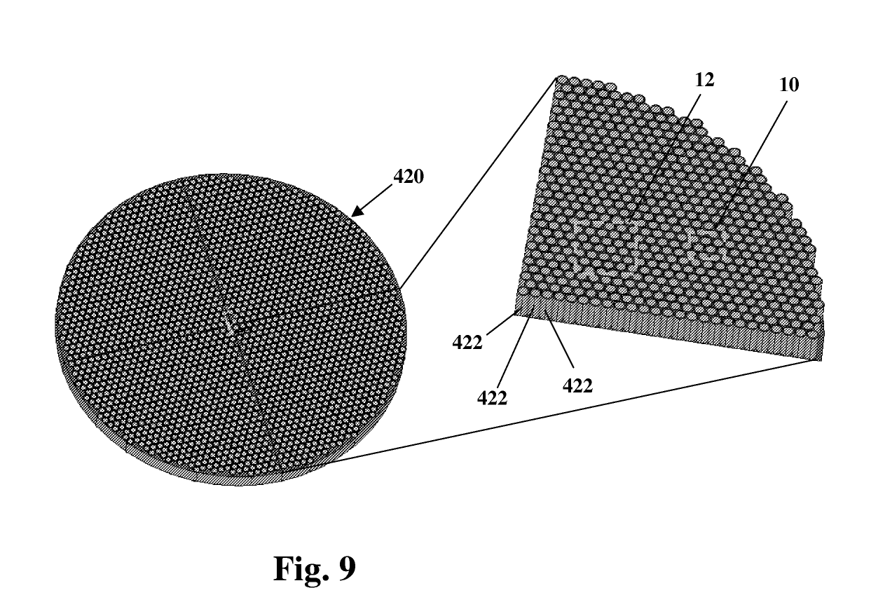

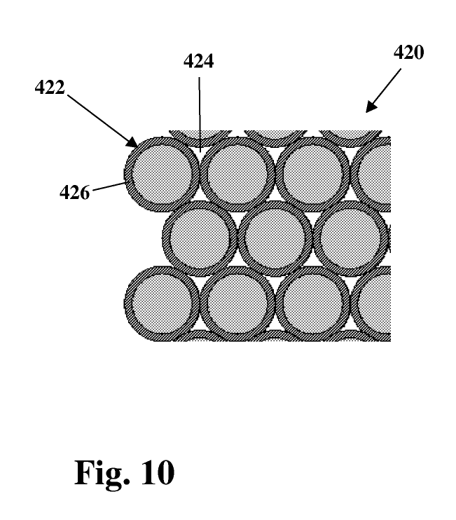

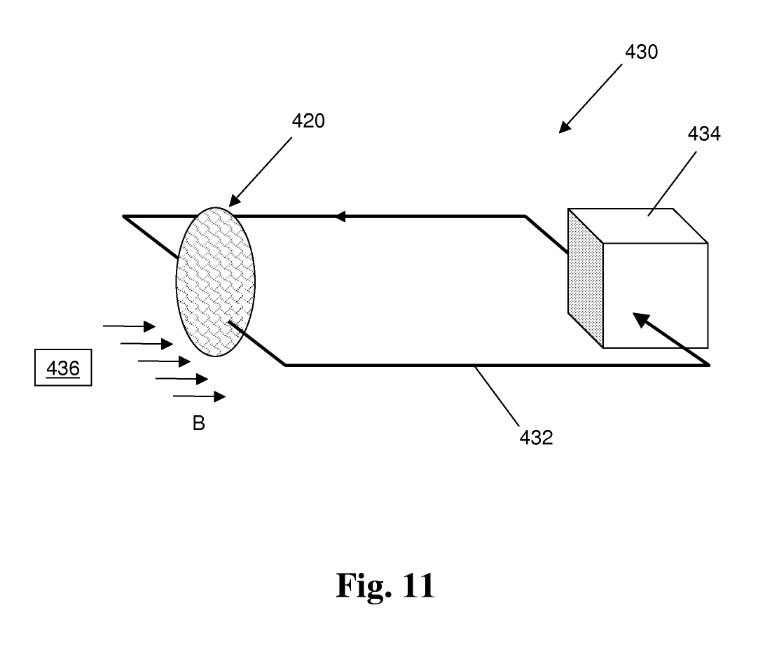

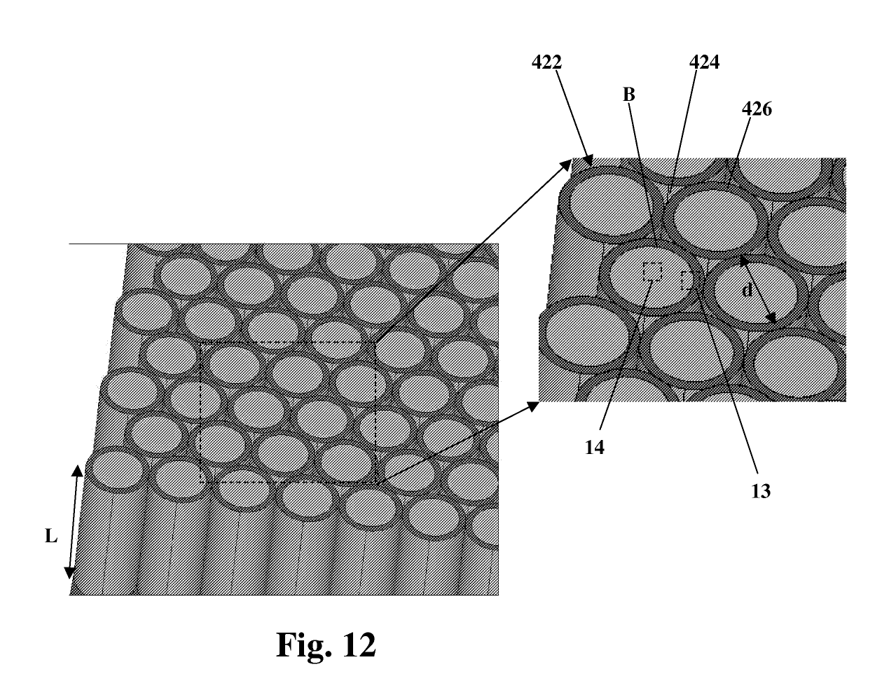

As an example, referring to FIGS. 9-11, the above described methods may be utilized in making a regenerator 420 for use in a magnetic refrigeration system 430. The regenerator 420 may include, for example, a series of cylindrical rod-like structures 422 that are fused together to form a planar bed. The rod-like structures 422 may have cross sections that are, for example, round, triangular, rectangular, hexagonal (e.g., arranged in a honeycomb configuration), etc., and may be formed substantially of magnetocaloric material 402, as discussed further below. The rod-like structures 422 may also be configured so as to define therebetween hollow areas 424 that extend substantially parallel with the rod-like structures.

A working fluid 432 (e.g., water) may be directed through the hollow areas 424 and circulated between the heat regenerator 420 and a refrigerated compartment 434. A magnetic field generating component 436 (e.g., a movable permanent magnet and/or an electromagnet) can be configured to vary a magnetic field B to which the regenerator 420 is exposed, thereby causing a change in temperature of the magnetocaloric material 402 of the rod-like structures 422. As the working fluid 432 is directed through the hollow areas 424, it can exchange heat with the magnetocaloric material 402, for example, cooling the working fluid. Thereafter, the cooled working fluid 432 can move into thermal contact with the refrigerated compartment 434 to receive heat therefrom.

In order to enhance the thermal performance of the magnetic refrigeration system 430, efficient thermal contact may be facilitated between the working fluid 432 in the hollow areas 424 and the magnetocaloric material 402 in the rod-like structures 422. It may therefore be desirable to increase the length L of the rod-like structures 422 and/or decrease the diameter d. However, magnetocaloric materials often tend to be somewhat brittle, and therefore may be difficult to form into complex shapes such as the rod-like structures 422 (or other similarly high surface area geometries). As a further complication, many magnetocaloric materials tend to have relatively high melting temperatures and/or may be prone to oxidation at high temperatures, thereby further reducing the options for manufacturing components of magnetocaloric materials.

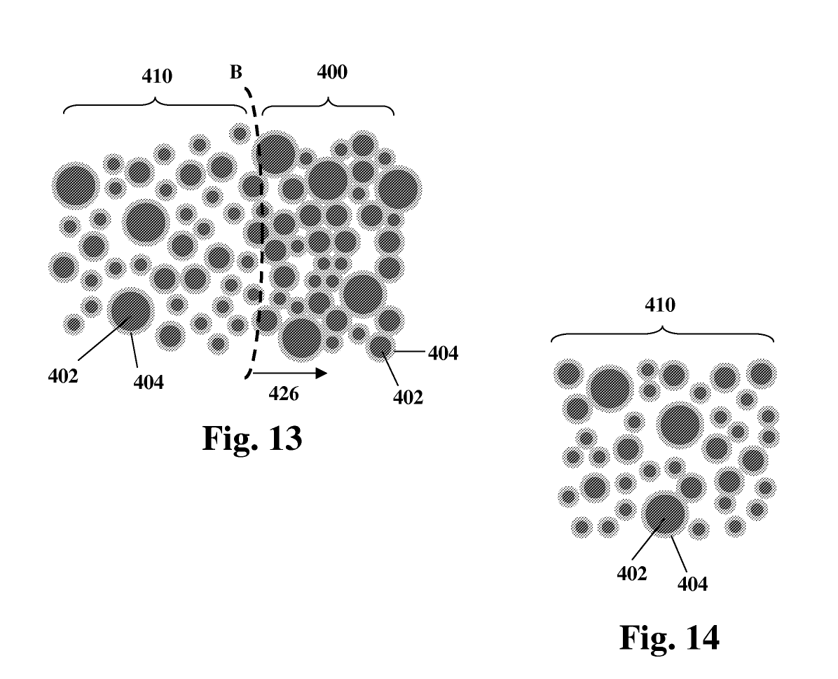

The above limitations notwithstanding, the methods disclosed herein may allow for the production of the regenerator 420 with rod-like structures 422 with lengths L of about 5 mm and diameters d of about 500 μm. The rod-like structures 422 may include, for example, a granular gadolinium-based magnetocaloric material 402, the granules of which are coated with, say, nickel-50 atomic percent iron (Ni-50 Fe) 404. At the peripheries of the rod-like structures 422 (see FIG. 13), the Ni-50 Fe coatings may be sintered together so as to bind the granules of magnetocaloric material 402. Alternatively, the Ni-50 Fe-coated granules of magnetocaloric material 402 may remain separated at interior portions of the rod-like structures 422 (FIG. 14). The otherwise unbound granules in the interior may be confined by walls 426 formed of a composition 400 of granules of magnetocaloric material bound together by a contiguous sintered matrix of Ni-50 Fe 404, with the walls forming a wall boundary B with the unbound aggregate in the interior.

While only certain features of the invention have been illustrated and described herein, many modifications and changes will occur to those skilled in the art. For example, while the above has described compositions including a granular first material bound together by a second material, in some embodiments, the second material may be excluded, and the granules of the granular first material may be sintered directly together. This can be accomplished, for example, by supplying a higher amount of energy to the granules than may have otherwise been required in order to induce sintering in the “sinterable” second material. It is, therefore, to be understood that the appended claims are intended to cover all such modifications and changes as fall within the true spirit of the invention.

What is claimed:

1. A composition comprising:
a granular first material; and
a substantially contiguous second material interspersed with said granular first material.

2. The composition of claim 1, wherein said granular first material has granules with diameters less than or equal to about 500 μm.

3. The composition of claim 1, wherein said granular first material includes magnetocaloric material.

4. The composition of claim 1, wherein said granular first material has a melting temperature greater than or equal to about 400° C.

5. The composition of claim 1, wherein said second material has a melting temperature less than or equal to about 1500° C.

6. The composition of claim 1, wherein said granular first material constitutes greater than or equal to about 50 volume percent of said composition.

7. The composition of claim 1, wherein said contiguous second material is configured so as to bind together said granular first material.

8. The composition of claim 1, wherein said granular first material has a strain to failure of less than 1% at room temperature.

9. The composition of claim 1, wherein said granular first material has a melting temperature greater than a melting temperature of said second material.

10. A method comprising:
providing a granular first material;
providing a sinterable second material;
combining the granular first material and the sinterable second material to form an aggregate; and
performing localized sintering of the aggregate.

11. The method of claim 10, wherein said providing a granular first material includes providing a granular first material having a melting temperature greater than or equal to about 400° C.

12. The method of claim 10, wherein said providing a sinterable second material includes providing a metal having a melting temperature less than or equal to about 1500° C.

13. The method of claim 10, wherein said providing a sinterable second material includes providing a granular, sinterable second material, and wherein said combining the granular first material and the sinterable second material to form an aggregate includes mixing the granular first material and the granular, sinterable second material.

14. The method of claim 10, wherein said providing a sinterable second material includes providing a second material source, and wherein said combining the granular first material and the sinterable second material to form an aggregate includes coating the second material onto the granular first material.

15. The method of claim 10, wherein said providing a granular first material includes providing a granular first material having a strain to failure of less than 1% at room temperature.

16. The method of claim 10, wherein said performing localized sintering of the aggregate includes performing localized sintering of the aggregate such that, subsequent to localized sintering, the second material is substantially contiguous and binds the granular first material.

17. The method of claim 10, wherein said providing a granular first material and said providing a sinterable second material include providing a granular first material and a sinterable second material such that the granular first material constitutes greater than or equal to about 50 volume percent of the aggregate.

18. The method of claim 10, wherein said providing a granular first material includes providing a granular first material having granules with diameters less than or equal to about 100 μm.

19. The method of claim 10, wherein said performing localized sintering of the aggregate includes heating using a source selected from the group consisting of a laser, a microwave radiation source, a radio frequency radiation source, an infrared radiation source, and an ultraviolet radiation source.

20. The method of claim 10, further comprising exposing the granular first material to an isotropic chemical etchant.

21. The method of claim 10, wherein said providing a granular first material includes providing a granular magnetocaloric material.

22. The method of claim 21, further comprising:
incorporating the aggregate into a regenerator;
providing a magnetic field generating component configured to vary a magnetic field to which the magnetocaloric material is exposed; and
directing a working fluid along the regenerator so as to exchange heat with the magnetocaloric material.

23. An apparatus comprising:
a regenerator including a granular magnetocaloric material and a contiguous second material interspersed with and binding together said granular magnetocaloric material;
a magnetic field generating component configured to vary a magnetic field to which said magnetocaloric material is exposed; and
a working fluid directed along said regenerator so as to exchange heat with said magnetocaloric material.
